(19) United States
(12) Patent Application Publication
(10) Pub. No.: US 2008/0081862 A1
(43) Pub. Date: Apr. 3, 2008

(54) Fiber reinforced polystyrene composites

(76) Inventors: Arnold Lustiger, Edison, NJ (US); Walter T. Matuszek, Easton, PA (US)

Correspondence Address: ExxonMobil Research and Engineering Company, P. O. Box 900, Annandale, NJ, 08801-0900, US

(21) Appl. No.: 11/542,521

(22) Filed: Oct. 3, 2006

(51) Int. Cl. C08K 3/26

(52) U.S. Cl. 524/425

(57) ABSTRACT

The present invention is directed generally to fiber reinforced polystyrene compositions, and the beneficial mechanical properties imparted by such compositions. The fiber reinforced polystyrene compositions include from 5 to 50 wt % organic fiber, and from 0 to 60 wt % inorganic filler in a matrix of an atactic polystyrene based polymer. Lubricant may also be optionally incorporated into the composition to assist with fiber pullout. Colored fiber may also be optionally incorporated into the composition to yield an article with a cloth-like appearance. Articles molded from these fiber reinforced polystyrene compositions have a flexural modulus of at least 350,000 psi, and exhibit ductility during instrumented impact testing. The fiber reinforced polystyrene compositions are suitable for making molded articles including, but not limited to, household appliances, automotive parts, and boat hulls.

### FIELD OF THE INVENTION

The present invention is directed generally to fiber reinforced polystyrene compositions having a flexural modulus of at least 350,000 psi and exhibiting ductility during instrumented impact testing. It also relates to articles molded from such fiber reinforced polystyrene compositions.

### BACKGROUND OF THE INVENTION

Polystyrenes have limited use in engineering applications due to the tradeoff between toughness and stiffness. For example, atactic polystyrene is widely regarded as being relatively stiff, but suffers from poor toughness.

Several well known polystyrene compositions have been introduced which address toughness. For example, it is known to increase the toughness of atactic polystyrene by adding impact modifiers, such as rubber-like polymers. Rubber-like polymers include natural rubber, polybutadiene, polyisoprene, polyisobutylene, neoprene, polysulfide rubber, thiol rubber, acryl rubber, urethane rubber, silicone rubber, epichlorohydrin rubber, a styrene-butadiene block copolymer (SBR), a hydrogenated styrene-butadiene block copolymer (SEB, SBEC), a styrene-butadiene-styrene block copolymer (SBS), a hydrogenated styrene-butadiene-styrene block copolymer (SEBS), a styrene-isoprene block copolymer (SIR), a hydrogenated styrene-isoprene block copolymer (SEP), a styrene-isoprene-styrene copolymer (SIS), a hydrogenated styrene-isoprene-styrene block copolymer (SEPS), ethylene-propylene rubber (EPM), or ethylene-propylene-diene rubber (EPDM). Other examples also include core-shell type granular elastic substances such as butadiene-acrylonitrile-styrene core-shell rubber (ABS), methyl methacrylate-butadiene-styrene core-shell rubber (MBS), methyl methacrylate-butyl acrylate-styrene core-shell rubber (MAS), octyl acrylate-butadiene-styrene core-shell rubber (MABS), alkyl acrylate-butadiene-acrylonitrile-styrene core-shell rubber (AABS), butadiene-styrene core-shell rubber (SBR), or siloxane-containing core-shell rubber such as methyl methacrylate-butyl acrylate-siloxane core-shell rubber, and modified rubber thereof. However, while toughness is improved, the stiffness maybe considerably reduced using this approach. The rubber-like elastic polymers are incorporated into the polystyrene in an amount of generally 60 wt. % or less with higher loading results in a greater decrease in stiffness.

Household appliances, boat hulls, and automotive parts often require a unique combination of toughness, stiffness and aesthetics. Many interior automotive parts also require a cloth-like appearance and feel. To create such a cloth-like look in polypropylene (PP) or thermoplastic olefin (TPO) materials, various fiber based additives are added to a base polymer product. Typically the base material is a light gray color and the fiber based additives are a darker gray or blue color to create the cloth-like effect. However, the presence of these fibers causes a significant decrease in impact properties. To counter balance the loss of impact resistance, typically plastomers or ethylene-propylene-diene rubber (EPDM) are added. However these modifiers also lower the stiffness (flexural modulus) of the product, and substantially increase the raw material cost.

A need exists for an improved polystyrene based material that yields a combination of improved impact resistance/toughness, and stiffness for use in molded articles. In addition, the polystyrene based material when formed into molded articles will ideally not splinter after subjected to break through drop weight impact testing, and optionally may have a cloth-like appearance and feel.

### SUMMARY OF THE INVENTION

It has surprisingly been found that fiber reinforced polystyrene compositions can be made which simultaneously have a flexural modulus of at least 350,000 psi and exhibit ductility during instrumented impact testing. Such fiber reinforced polystyrene compositions may be made using a wide range of atactic polystyrene based polymers as the matrix material, including polystyrenes that without fiber are very brittle. Cloth-like fiber reinforced polystyrene compositions may also be made which simultaneously have a flexural modulus of at least 350,000 psi and exhibit ductility during instrumented impact testing. The cloth-like fiber reinforced polystyrene compositions exhibit no decrease in impact properties upon the incorporation of colorant fiber needed to attain a cloth-like look. The polystyrene compositions of the present invention are particularly suitable for making articles including, but not limited to household appliances, automotive parts, and boat hulls.

According to the present disclosure, an advantageous polystyrene resin composition comprises: (a) at least 30 wt %, based on the total weight of the composition, atactic polystyrene based polymer; (b) from 5 to 50 wt %, based on the total weight of the composition, organic fiber; and (c) from 0 to 60 wt %, based on the total weight of the composition, inorganic filler; wherein an article molded from said composition has a flexural modulus of at least 350,000 psi and exhibits ductility during instrumented impact testing.

Another aspect of the present disclosure relates to an advantageous polystyrene resin composition comprising: (a) at least 30 wt %, based on the total weight of the composition, atactic polystyrene based polymer; (b) from 5 to 50 wt %, based on the total weight of the composition, organic fiber; (c) from 0 to 60 wt %, based on the total weight of the composition, inorganic filler; and (d) from 0.01 to 0.2 wt %, based on the total weight of the composition, lubricant; wherein an article molded from said composition has a flexural modulus of at least 350,000 psi and exhibits ductility during instrumented impact testing.

Still another aspect of the present disclosure relates to an advantageous polystyrene resin composition comprising: (a) at least 35 wt %, based on the total weight of the composition, atactic polystyrene based polymer; (b) from 10 to 20 wt %, based on the total weight of the composition, polyester fiber; and (c) from 15 to 45 wt %, based on the total weight of the composition, talc; wherein an article molded from said composition has a flexural modulus of at least 750,000 psi and exhibits ductility during instrumented impact testing.

Still yet another aspect of the present disclosure relates to an advantageous polystyrene resin composition comprising: (a) at least 30 wt %, based on the total weight of the composition, atactic polystyrene based polymer; (b) from 5 to 50 wt %, based on the total weight of the composition, organic fiber; (c) from 0 to 60 wt %, based on the total weight of the composition, inorganic filler; and (d) from 0.1 to 2.5 wt %, based on the total weight of the composition, colorant fiber; wherein an article molded from said composition has a flexural modulus of at least 350,000 psi, exhibits ductility during instrumented impact testing, and exhibits a cloth-like appearance.

These and other features and attributes of the disclosed polystyrene resin compositions of the present disclosure and their advantageous applications and/or uses will be apparent from the detailed description which follows.

### DETAILED DESCRIPTION OF THE INVENTION

The present invention relates to improved fiber reinforced polystyrene compositions for use in molding applications. The fiber reinforced polystyrene compositions of the present invention include a combination of an atactic polystyrene based polymer matrix with organic fiber and inorganic filler, which in combination advantageously yield articles molded from the compositions with a flexural modulus of at least 350,000 psi and ductility during instrumented impact testing (15 mph, −29° C., 25 lbs). In addition, fiber reinforced polystyrene compositions of the present invention do not splinter during instrumented impact testing, and may be optionally produced to yield a cloth-like look and feel. All numerical values within the detailed description and the claims herein are understood as modified by “about.”

The fiber reinforced polystyrene compositions of the present invention simultaneously have desirable stiffness, as measured by having a flexural modulus of at least 350,000 psi, and toughness, as measured by exhibiting ductility during instrumented impact testing. In a particular embodiment, the compositions have a flexural modulus of at least 799,000 psi, or at least 1,540,000. It is also believed that having a weak interface between the polystyrene matrix and the fiber contributes to fiber pullout; and, therefore, may enhance toughness. Thus, there is no need to add modified polystyrenes to enhance bonding between the fiber and the polystyrene matrix, although the use of modified polystyrene may be advantageous to enhance the bonding between a filler, such as talc or wollastonite, and the matrix. In addition, in one embodiment, there is no need to add lubricant to weaken the interface between the polystyrene and the reinforcing fiber to further enhance fiber pullout. Some embodiments also display no splintering during instrumented dart impact testing, which yield a further advantage of not subjecting a person in close proximity to the impact to potentially harmful splintered fragments. This characteristic is advantageous in automotive applications.

Compositions of the present invention generally include at least 30 wt %, based on the total weight of the composition, of polystyrene as the matrix resin. In a particular embodiment, the polystyrene is present in an amount of at least 30 wt %, or at least 35 wt %, or at least 40 wt %, or at least 50 wt %, or at least 60 wt %, or at least 70 wt %, or in an amount within the range having a lower limit of 30 wt %, and an upper limit of 80 wt %, based on the total weight of the composition.

The polystyrene used as the matrix resin of the present invention is a styrene based polymer having an atactic structure and is therefore amorphous. The term styrene based polymer refers to any solid homopolymer or copolymer of styrene with an atactic structure having a softening point not less than 70° C. The styrene polymers having an atactic steric structure that may be used in the present invention are polymers which can be produced through solvent polymerization, bulk polymerization, suspension polymerization, or bulk-suspension polymerization, and comprise: a polymer formed of one or more aromatic vinyl compounds represented by the following formula (1) below; a copolymer of one or more aromatic vinyl compounds and one or more other vinyl monomers which are copolymerizable with the aromatic vinyl compounds; a hydrogenated polymer thereof; and a mixture thereof.

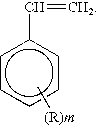

wherein R represents a hydrogen atom, a halogen atom, or a substituent containing one or more atoms selected from among a carbon atom, an oxygen atom, a nitrogen atom, a sulfur atom, a phosphorus atom, a selenium atom, a silicon atom, and a tin atom; m is an integer between 1 and 3 inclusive, and when m is 2 or 3, a plurality of R's may be identical to or different from one another.

Examples of aromatic vinyl compounds which may be used include styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, and ethoxystyrene. These may be used singly or in combination of two or more species. Of these, styrene, p-methylstyrene, m-methylstyrene, p-tertiary butylstyrene, p-chlorostyrene, m-chlorostyrene, and p-fluorostyrene are particularly preferred.

Examples of other copolymerizable vinyl monomers include vinylcyan compounds such as acrylonitrile, or methacrylonitrile; acrylate esters such as methyl acrylate, ethyl acrylate, propyl acrylate, butyl acrylate, amyl acrylate, hexyl acrylate, octyl acrylate, 2-ethylhexyl acrylate, cyclohexyl acrylate, dodecyl acrylate, octadecyl acrylate, phenyl acrylate, or benzyl acrylate; methacrylate esters such as methyl methacrylate, ethyl methacrylate, butyl methacrylate, amyl methacrylate, hexyl methacrylate, octyl methacrylate, 2-ethylhexyl methacrylate, cyclohexyl methacrylate, dodecyl methacrylate, octadecyl methacrylate, phenyl methacrylate, or benzyl methacrylate; maleimide compounds such as maleimide, N-methylmaleimide, N-ethylmaleimide, N-butylmaleimide, N-laurylmaleimide, N-cyclohexylmaleimide, N-phenylmaleimide, or N-(p-bromophenyl)maleimide.

Other copolymerizable vinyl monomers include rubber-like polymers. Examples of copolymerizable rubber-like polymers include diene rubber such as polybutadiene, a styrene-butadiene copolymer, an acrylonitrile-butadiene copolymer, or polyisoprene; non-diene rubber such as an ethylene-α-olefin copolymer, an ethylene-α-olefin-polyene copolymer, or poly(acrylate ester); a styrene-butadiene block copolymer; a hydrogenated styrene-butadiene block copolymer; an ethylene-propylene elastomer; a styrene-graft-ethylene-propylene elastomer; an ethylenic ionomer resin; and a hydrogenated styrene-isoprene copolymer.

No particular limitation is imposed on the molecular weight of the atactic polystyrene. The weight-average molecular weight of the atactic polystyrene is generally 10,000 or more, and more particularly from 50,000 to 2,000,000. In a particular embodiment, the weight-average molecular weight of the atactic polystyrene is greater than or equal to 500,000, greater than or equal to 750,000, greater than or equal to 1,000,000, greater than or equal to 1,250,000, greater than or equal to 1,500,000 and still more particularly greater than 1,750,000. When the weight-average molecular weight is less than 10,000, the resultant molded articles disadvantageously have poor thermal and mechanical properties. Also, no particular limitation is imposed on the molecular weight distribution of the atactic polystyrene based polymer, and a wide range thereof may be used.

The polystyrene of the matrix resin may have a melt flow rate of from 1 to 100 g/10 min. In a particular embodiment, the melt flow rate of the polystyrene matrix resin is greater than or equal to 10 g/10 min, greater than or equal to 15 g/10 min, greater than or equal to 20 g/10 min, greater than or equal to 25 g/min, and still more particularly greater than 30 g/10 min. The higher melt flow rate permits for improvements in processability, throughput rates, and higher loading levels of organic fiber and inorganic filler without negatively impacting flexural modulus and impact resistance.

The atactic polystyrene based polymer may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polystyrene matrix is generally from 0.1 wt %, or 1.0 wt %, or 2.5 wt %, or 7.5 wt %, or 10 wt %, based on the total weight of the matrix. Diffusion of additive(s) during processing may cause a portion of the additive(s) to be present in the fiber.

The polystyrene composites of the present invention do not require the blending of a rubber-like elastic polymer substance in order to improve the impact resistance. In order to improve the impact resistance, organic fibers, also referred to as reinforcing fibers, are incorporated into the atactic polystyrene based polymer matrix.

Compositions of the present invention generally include at least 5 wt %, based on the total weight of the composition, of an organic fiber. In a particular embodiment, the fiber is present in an amount of at least 7.5 wt %, or at least 10 wt %, or at least 12.5 wt %, or at least 15 wt %. More particularly, the organic fiber is present in an amount within the range having a lower limit of 5 wt %, or 7.5 wt %, or 10 wt %, or 12.5 wt %, and an upper limit of 15 wt %, or 20 wt %, or 30 wt %, or 50 wt %, based on the total weight of the composition.

The polymer used as the fiber is not particularly restricted and is generally chosen from polyalkylene terephthalates, polyalkylene naphthalates, polyamides, polyolefins, polyacrylonitrile, and combinations thereof. In a particular embodiment, the fiber comprises a polymer chosen from polyethylene terephthalate (PET), polybutylene terephthalate, polyamide and acrylic. In another particular embodiment, the organic fiber comprises PET. In one particular embodiment, at a PET fiber loading of 15 wt %, the polystyrene fiber composite exhibited a flexural modulus of 1,540,000 psi and no splintering during instrumented impact testing (15 mph, −29° C., 25 lbs). In another particular embodiment, at a PET fiber loading of 12.5 wt %, the polystyrene fiber composite exhibited a flexural modulus of 799,000 psi and no splintering during instrumented impact testing (15 mph, −29° C., 25 lbs).

In one embodiment, the reinforcing fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the reinforcing fibers of the present invention are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The reinforcing fiber may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment.

The reinforcing fiber used to make the compositions of the present invention is not limited by any particular fiber form. For example, the fiber can be in the form of continuous filament yarn, partially oriented yarn, or staple fiber. In another embodiment, the fiber may be a continuous multifilament fiber or a continuous monofilament fiber.

In another embodiment of the present invention, the fiber reinforced polystyrene compositions further include from 0.01 to 0.2 wt %, or more particularly from 0.05 to 0.1 wt % lubricant, based on the total weight of the composition. Suitable lubricants include, but are not limited to, silicon oil, silicon gum, fatty amide, paraffin oil, paraffin wax, ester oil, and combinations thereof. Lubricant incorporation may assist with the pull-out of organic fiber from the atactic styrene based matrix polymer to further improve impact resistance.

In another exemplary embodiment of the present invention, the fiber reinforced polystyrene composition may be made cloth-like in terms of appearance, feel, or a combination thereof. Cloth-like appearance or look is defined as having a uniform short fiber type of surface appearance. Cloth-like feel is defined as having a textured surface or fabric type feel. The incorporation of the colorant fiber into the fiber reinforced polystyrene composition results in a cloth-like appearance. When the fiber reinforced polystyrene composition is processed through a mold with a textured surface, a cloth-like feel is also imparted to the surface of the resulting molded part.

Cloth-like fiber reinforced polystyrene compositions of the present invention generally include from 0.1 to 2.5 wt %, or from 0.5 to 1.5 wt %, based on the total weight of the composition, of a colorant fiber. In one particular embodiment, the colorant fiber is present at less than 1.0 wt %, based on the total weight of the composition.

The colorant fiber type is not particularly restricted and is generally chosen from cellulosic fiber, acrylic fiber, nylon fiber or polyester type fiber. Polyester type fibers include, but are not limited to, polyethylene terephthalate, polybutylene terephthalate, and polyethylene naphthalate. Polyamide type fibers include, but are not limited to, nylon 6, nylon 6,6, nylon 4,6 and nylon 6,12. In a particular embodiment, the colorant fiber is cellulosic fiber, also commonly referred to as rayon. In another particular embodiment, the colorant fiber is a nylon type fiber.

The colorant fiber used to make the compositions of the present invention is not limited by any particular fiber form prior to being chopped for incorporation into the fiber reinforced polystyrene composition. For example, the colorant fiber can be in the form of continuous filament yarn, partially oriented yarn, or staple fiber. In another embodiment, the colorant fiber may be a continuous multifilament fiber or a continuous monofilament fiber.

The length and diameter of the colorant fiber may be varied to alter the cloth-like appearance in the molded article. The length and diameter of the colorant fiber of the present invention is not particularly restricted. In a particular embodiment, the fibers have a length of less than ¼ inch, or more particularly a length of between 1/32 to ⅛ inch. In another particular embodiment, the diameter of the colorant fibers is within the range having a lower limit of 10 μm and an upper limit of 100 μm.

The colorant fiber is colored with a coloring agent, which comprises either inorganic pigments, organic dyes or a combination thereof. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Exemplary pigments and dyes incorporated into the colorant fiber include, but are not limited to, phthalocyanine, azo, condensed azo, azo lake, anthraquinone, perylene/perinone, indigo/thioindigo, isoindolinone, azomethineazo, dioxazine, quinacridone, aniline black, triphenylmethane, carbon black, titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatments in a manner known per se in the art. Depending on the material to be colored, the coloring agent can be added with one or more of various additives such as organic solvents, resins, flame retardants, antioxidants, ultraviolet absorbers, plasticizers and surfactants.

The base fiber reinforced polystyrene composite material that the colorant fiber is incorporated into may also be colored using the inorganic pigments, organic dyes or combinations thereof. Exemplary pigments and dyes for the base fiber reinforced polystyrene composite material may be of the same types as indicated in the preceding paragraph for the colorant fiber. Typically the base fiber reinforced polystyrene composite material is made of a different color or a different shade of color than the colorant fiber, such as to create a cloth-like appearance upon uniformly dispersing the short colorant fibers in the colored base fiber reinforced polystyrene composite material. In one particular exemplary embodiment, the base fiber reinforced polystyrene composite material is light grey in color and the colorant fiber is dark grey or blue in color to create a cloth-like look from the addition of the short colorant fiber uniformly dispersed through the base fiber reinforced polystyrene composite material.

The colorant fiber in the form of chopped fiber may be incorporated directly into the base fiber reinforced polystyrene composite material via the twin screw extrusion compounding process, or may be incorporated as part of a masterbatch resin to further facilitate the dispersion of the colorant fiber within the fiber reinforced polystyrene composite base material. When the colorant fiber is incorporated as part of a masterbatch resins, exemplary carrier resins include, but are not limited to, atactic polystyrene, syndiotactic polystyrene, impact modified polystyrene, copolymers of polystyrene, polypropylene homopolymer, ethylene-propylene copolymer, ethylene-propylene-butene-1 terpolymer, propylene-butene-1 copolymer, low density polyethylene, high density polyethylene, and linear low density polyethylene. In one exemplary embodiment, the colorant fiber is incorporated into the carrier resin at less than 25 wt %. The colorant fiber masterbatch is then incorporated into the fiber reinforced polystyrene composite base material at a loading of from 1 wt % to 10 wt %, and more particularly from 2 to 6 wt %. In one embodiment, the colorant fiber masterbatch is added at 4 wt % based on the total weight of the composition. In another exemplary embodiment, a masterbatch of either black rayon or black nylon type fibers in linear low density polyethylene carrier resin is incorporated at a loading of 4 wt % in the fiber reinforced polystyrene composite base material.

The colorant fiber or colorant fiber masterbatch may be fed to the twin screw extrusion compounding process with a gravimetric feeder at either the feed hopper or at a downstream feed port in the barrel of the twin screw extruder. Kneading and mixing elements are incorporated into the twin screw extruder screw design downstream of the colorant fiber or colorant fiber masterbatch injection point, such as to uniformly disperse the colorant fiber within the cloth-like fiber reinforced polystyrene composite material.

Compositions of the present invention optionally include inorganic filler in an amount of at least 5 wt %, or at least 10 wt %, or at least 15 wt %, or at least 20 wt %, based on the total weight of the composition. The inorganic filler is included at an upper limit of 40 wt %, or 50 wt %, or 60 wt %, based on the total weight of the composition. In a particular embodiment, the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from 1 to 100 microns.

In one particular embodiment, at a talc loading of up to about 40 wt %, the polystyrene fiber composite exhibited a flexural modulus of 1,540,000 psi and no splintering during instrumented impact testing (15 mph, −29° C., 25 lbs). In another particular embodiment, at talc loading of 20 wt %, the polystyrene fiber composite exhibited a flexural modulus of 799,000 psi and no splintering during instrumented impact testing (15 mph, −29° C., 25 lbs). In addition, wollastonite loadings of from 5 wt % to 60 wt % in the polystyrene fiber composite yield an outstanding combination of impact resistance and stiffness.

In one exemplary embodiment, a fiber reinforced polystyrene composition including an atactic polystyrene based resin, 5 to 50 wt % of polyester fiber, and 0 to 60 wt % of talc yields a flexural modulus of at least 350,000 and did not shatter during instrumented impact testing at −29 degrees centigrade, tested at 25 pounds and 15 miles per hour. In another particular embodiment, a fiber reinforced polystyrene composition including an atactic polystyrene homopolymer with a melt flow rate of 20, 12 to 15 wt % of polyester fiber, and 20 to 41 wt % of talc displayed a flexural modulus of at least 799,000 and did not shatter during instrumented impact testing at −29 degrees centigrade, tested at 25 pounds and 15 miles per hour. This combination of stiffness and toughness is difficult to achieve in a polymeric based material.

The fiber reinforced polystyrene based composites of the present invention allow for an approximately doubling of the stiffness of the composites for a given level of inorganic filler and organic fiber in comparison to fiber reinforced polypropylene based composites. As a result, fiber reinforced polystyrene composites of the present invention allow for a reduction in the inorganic filler loading while still maintaining stiffness in comparison to fiber reinforced polypropylene composites. A lower filler loading improves part surface quality and lowers the density of the parts reduced. Correspondingly, this permits fiber reinforced polystyrene composites to be used in exterior automotive applications where paint appearance is important. High filler loadings needed for stiffness in fiber reinforced polypropylene composites have a deleterious effect on part surface smoothness, thereby limiting the use of these materials in exterior automotive applications where paint appearance is important. This limitation does not exist for fiber reinforced polystyrene composites of the present invention.

In another embodiment, the present invention provides for parts molded from such fiber reinforced polystyrene compositions. Articles made from the fiber-reinforced polystyrene compositions described herein include, but are not limited to, automotive parts, household appliances, and boat hulls. Automotive parts include both interior and exterior automobile parts. Cloth-like fiber reinforced polystyrene articles are particularly suitable for interior automotive parts because of the unique combination of toughness, stiffness and aesthetics. More particularly, the non-splintering nature of the failure mode during instrumented impact testing, and the cloth-like look make the cloth-like fiber reinforced polystyrene composites of the present invention particularly suited for interior automotive parts, and even more particularly suited for interior trim cover panels. Exemplary, but not limiting, interior trim cover panels include steering wheel covers, head liner panels, dashboard panels, interior door trim panels, pillar trim cover panels, and under-dashboard panels. Pillar trim cover panels include a front pillar trim cover panel, a center pillar trim cover panel, and a quarter pillar trim cover panel. Other interior automotive parts include package trays, and seat backs. Articles made from the polystyrene compositions described herein are also suitable for exterior automotive parts, including, but not limited to, bumpers, aesthetic trim parts, body panels, under body parts, under hood parts, door cores, and other structural parts of the automobile.

Articles of the present invention are made by forming a fiber-reinforced polystyrene resin composition and then molding the resin composition to form the article. Injection molding is one exemplary method for molding parts from the fiber-reinforced polystyrene resin composition. The invention is not limited by any particular method for forming the resin composition. For example, the resin composition may be formed by contacting polystyrene, organic fiber, and optional inorganic filler in any of the well known processes of pultrusion or extrusion compounding. In a particular embodiment, the resin composition is formed in an extrusion compounding process (single screw or twin screw compounder). In a particular aspect of this embodiment, the organic fibers are cut prior to being metered in the extruder hopper. In another particular aspect of this embodiment, the organic fibers are fed directly from one or more spools into the extruder hopper of the extrusion compounding process. In yet another particular aspect of this embodiment, the cut organic fibers are metered into the extrusion compounding process downstream of the extruder hopper.

The fiber reinforced polystyrene composites of the present invention include, but are not limited to, one or more of the following advantages: an advantageous combination of toughness, stiffness, and aesthetics, improved instrumented impact resistance, improved flexural modulus, improved splinter or shatter resistance during instrumented impact testing, fiber pull out during instrumented impact testing without the need for lubricant additives, ductile (non-splintering) failure mode during instrumented impact testing as opposed to brittle (splintering), a higher heat distortion temperature compared to rubber modified polystyrene, improved part surface appearance from lower inorganic filler loadings, lower part density from lower inorganic filler loadings, a lower flow and cross flow coefficient of linear thermal expansion compared to rubber modified polystyrene, the ability to continuously and accurately feed organic reinforcing fiber into a compounding extruder, reduced production costs and reduced raw material costs, improved part surface appearance, the ability to produce polystyrene fiber composites exhibiting a cloth-like look and/or feel, uniform dispersion of the organic reinforcing fiber and colorant fiber in the composite pellets, and retention of impact resistance, ductile failure mode and stiffness after the incorporation of colorant with colorant fiber.

The following examples illustrate the present invention and the advantages thereto without limiting the scope thereof.

### Test Methods

Fiber reinforced polystyrene compositions described herein were injection molded at 2300 psi pressure, 401° C. at all heating zones as well as the nozzle, with a mold temperature of 60° C.

Flexural modulus data was generated for injected molded samples produced from the fiber reinforced polystyrene compositions described herein using the ISO 178 standard procedure.

Instrumented impact test data was generated for injected mold samples produced from the fiber reinforced polystyrene compositions described herein using ASTM D3763. Ductility during instrumented impact testing (test conditions of 15 mph, −29° C., 25 lbs) is defined as no splintering of the sample.

### EXAMPLES

SC208 is an atactic polystyrene homopolymer available from Supreme Petrochemical Limited. The melt flow rate (MFR) of the polystyrene was 20 grams per 10 min measured at 200° C. according to ASTM D1238.

V3837 is a high aspect ratio talc available from Luzenac America Inc. of Englewood, Colo.

One-quarter inch long PET fiber cut from a multifilament yarn available from Invista Corporation.

### Illustrative Example 1

Various mixtures of one-quarter inch long PET fiber cut from filament were mixed with SC208 atactic polystyrene (PS) homopolymer and V3837 talc. The mixing took place in a Haake single screw extruder, with mixing taking place at a temperature of 175° C. The strand that exited the extruder was cut into one half inch lengths, and subsequently injection molded using a Boy 50M ton injection molder at 205° C. into a mold held at 60° C. Injection pressures and nozzle pressures were all maintained at 2300 psi. Samples were molded in accordance with the geometry of ASTM D3763 and tested for mechanical and physical properties in comparison with a 100% atactic PS control sample. More particularly, samples were measured for instrumented impact under standard automotive conditions for interior parts (25 pounds at 15 miles per hour (MPH) at −29 C) and flexural modulus in accordance with ISO178. The results are shown in the table below.

TABLE 1

| | | | | | | Flexural |
|---|---|---|---|---|---|---|
| | wt % | wt % | | Total | Instrumented | modulus |
| | poly- | PET | wt % | Energy | Impact Test | (psi |
| Example # | styrene | Fiber | talc | (ft-lbf) | Results | chord) |
| 1 | 44 | 15 | 41 | 5.2 | ductile* | 1,540,000 |
| 2 | 67.5 | 12.5 | 20 | 4.6 | ductile/brittle** | 799,000 |
| 3 | 100 | 0 | 0 | <1 | brittle*** | — |

*Examples 1: samples did not shatter or split as a result of impact, with no pieces coming off of the specimen.
**Example 2: pieces broke off of the sample as a result of the impact.
***Example 3: samples completely shattered as a result of impact.

More significant than the energy to maximum load, the samples containing fiber loadings of 15 wt % did not shatter or split as a result of the impact, with no pieces coming off the specimen. At a 12.5 wt % fiber loading and lower talc composition, the samples still did not shatter, but displayed a mixed mode of both ductile and brittle behavior, with one piece of the instrumented impact samples breaking off the sample. In contrast, the polystyrene control sample shattered catastrophically under the same conditions of impact.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A polystyrene resin composition comprising:
(a) at least 30 wt %, based on the total weight of the composition, atactic polystyrene based polymer;
(b) from 5 to 50 wt %, based on the total weight of the composition, organic fiber; and
(c) from 0 to 60 wt %, based on the total weight of the composition, inorganic filler;
wherein an article molded from said composition has a flexural modulus of at least 350,000 psi and exhibits ductility during instrumented impact testing.

2. The composition of claim 1 wherein said atactic polystyrene based polymer is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene and combinations thereof.

3. The composition of claim 2 wherein said atactic polystyrene based polymer is produced from styrene.

4. The composition of claim 1 wherein said organic fiber is dispersed randomly within said atactic polystyrene based polymer.

5. The composition of claim 4 wherein said organic fiber is chosen from polyalkylene terephthalates, polyalkylene naphthalates, polyamides, polyolefins, polyacrylonitrile, and combinations thereof.

6. The composition of claim 5 wherein said organic fiber is polyethylene terephthalate.

7. The composition of claim 1 wherein said inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

8. The composition of claim 7 wherein said inorganic filler is talc or wollastonite.

9. The composition of claim 1 wherein said article molded from said composition has a flexural modulus of at least 750,000 psi.

10. The composition of claim 1 wherein said article molded from said composition has a flexural modulus of at least 1,500,000 psi.

11. The composition of claim 1 wherein said article is an automotive part, a household appliance part, or a boat hull.

12. The composition of claim 11 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.

13. A polystyrene resin composition comprising:
(a) at least 30 wt %, based on the total weight of the composition, atactic polystyrene based polymer;
(b) from 5 to 50 wt %, based on the total weight of the composition, organic fiber;
(c) from 0 to 60 wt %, based on the total weight of the composition, inorganic filler; and
(d) from 0.01 to 0.2 wt %, based on the total weight of the composition, lubricant;
wherein an article molded from said composition has a flexural modulus of at least 350,000 psi and exhibits ductility during instrumented impact testing.

14. The composition of claim 13 wherein said lubricant is chosen from silicon oil, silicon gum, fatty amide, paraffin oil, paraffin wax, ester oil, and combinations thereof.

15. The composition of claim 13 wherein said atactic polystyrene based polymer is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene and combinations thereof.

16. The composition of claim 15 wherein said atactic polystyrene based polymer is produced from styrene.

17. The composition of claim 13 wherein said organic fiber is chosen from polyalkylene terephthalates, polyalkylene naphthalates, polyamides, polyolefins, polyacrylonitrile, and combinations thereof.

18. The composition of claim 17 wherein said organic fiber is polyethylene terephthalate.

19. The composition of claim 13 wherein said inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

20. The composition of claim 19 wherein said inorganic filler is talc or wollastonite.

21. The composition of claim 13 wherein said article molded from said composition has a flexural modulus of at least 750,000 psi.

22. The composition of claim 13 wherein said article molded from said composition has a flexural modulus of at least 1,500,000 psi.

23. The composition of claim 13 wherein said article is an automotive part, a household appliance part, or a boat hull.

24. The composition of claim 23 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.

25. A polystyrene resin composition comprising:
(a) at least 35 wt %, based on the total weight of the composition, atactic polystyrene based polymer;
(b) from 10 to 20 wt %, based on the total weight of the composition, polyester fiber; and
(c) from 15 to 45 wt %, based on the total weight of the composition, talc;
wherein an article molded from said composition has a flexural modulus of at least 750,000 psi and exhibits ductility during instrumented impact testing.

26. The composition of claim 25 wherein said atactic polystyrene based polymer is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene and combinations thereof.

27. The composition of claim 26 wherein said atactic polystyrene based polymer is produced from styrene.

28. The composition of claim 25 wherein said polyester fiber is dispersed randomly within said atactic polystyrene based polymer.

29. The composition of claim 25 wherein said article is an automotive part, a household appliance part, or a boat hull.

30. The composition of claim 29 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.

31. A polystyrene resin composition comprising:
(a) at least 30 wt %, based on the total weight of the composition, atactic polystyrene based polymer;
(b) from 5 to 50 wt %, based on the total weight of the composition, organic fiber;
(c) from 0 to 60 wt %, based on the total weight of the composition, inorganic filler; and
(d) from 0.1 to 2.5 wt %, based on the total weight of the composition, colorant fiber;
wherein an article molded from said composition has a flexural modulus of at least 350,000 psi, exhibits ductility during instrumented impact testing, and exhibits a cloth-like appearance.

32. The composition of claim 31 further comprising:
(e) from 0.01 to 0.2 wt %, based on the total weight of the composition, lubricant.

33. The composition of claim 32 wherein said lubricant is chosen from silicon oil, silicon gum, fatty amide, paraffin oil, paraffin wax, ester oil, and combinations thereof.

34. The composition of claim 31 wherein said atactic polystyrene based polymer is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene and combinations thereof.

35. The composition of claim 34 wherein said atactic polystyrene based polymer is produced from styrene.

36. The composition of claim 31 wherein said organic fiber and said colorant fiber are dispersed randomly within said polystyrene based polymer.

37. The composition of claim 36 wherein said organic fiber is chosen from polyalkylene terephthalates, polyalkylene naphthalates, polyamides, polyolefins, polyacrylonitrile, and combinations thereof.

38. The composition of claim 37 wherein said organic fiber is polyethylene terephthalate.

39. The composition of claim 31 wherein said inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

40. The composition of claim 39 wherein said inorganic filler is talc or wollastonite.

41. The composition of claim 36 wherein said colorant fiber includes an inorganic pigment, an organic dye, or a combination thereof.

42. The composition of claim 41 wherein said colorant fiber is chosen from cellulosic fiber, acrylic fiber, nylon type fiber, polyester type fiber, and combinations thereof.

43. The composition of claim 42 wherein said colorant fiber is from 1/32 inch to ¼ inch in length.

44. The composition of claim 43 wherein said polystyrene based polymer further comprises an inorganic pigment, an organic dye, or a combination thereof.

45. The composition of claim 31 wherein said article molded from said composition has a flexural modulus of at least 750,000 psi.

46. The composition of claim 45 wherein said article molded from said composition has a flexural modulus of at least 1,500,000 psi.

47. The composition of claim 31 wherein said article is an automotive part, a household appliance part, or a boat hull.

48. The composition of claim 47 wherein said automotive part is an interior trim cover panel chosen from a steering wheel cover, a head liner panel, a dashboard panel, an interior door trim panel, a pillar trim cover panel, and an under-dashboard panel.
